(19) United States
(12) Patent Application Publication
(10) Pub. No.: US 2015/0153152 A1
(43) Pub. Date: Jun. 4, 2015

(54) MAGNETIC DEVICE FOR MEASURING SCOUR DEPTH

(71) Applicant: National Applied Research Laboratories, Hsinchu City (TW)

(72) Inventors: Chun-Ming HUANG, Hsinchu City (TW); Wei-Chang TSAI, Hsinchu City (TW); Chen-Chia CHEN, Hsinchu City (TW)

(73) Assignee: National Applied Research Laboratories, Hsinchu City (TW)

(21) Appl. No.: 14/140,313

(22) Filed: Dec. 24, 2013

(30) Foreign Application Priority Data
Dec. 2, 2013 (TW) 102144100

(51) Int. Cl. G01B 7/26; G01V 3/08

(52) U.S. Cl. CPC G01B 7/26; G01V 3/08

(57) ABSTRACT

The present invention provides a magnetic device for measuring scour depth. The magnetic device comprises a plurality of scour detecting units which are buried in the sediment and disposed at intervals along the direction perpendicular to the surface of water. Each scour detecting unit comprises: one or more magnetic sources; and one or more magnetic detecting elements configured to be apart from the magnetic source for a predetermined distance. The magnetic detecting element is utilized to detect the magnetic field generated by the magnetic source. The scour depth and the position where scour occurs are determined according to electronic signals corresponding to the magnetic strength detected by the respective magnetic detecting elements of the scour detecting units. The magnetic device of the present invention has many advantages including low cost, high efficiency, and such a device is easily deployed.

### TECHNICAL FIELD OF THE INVENTION

The present invention relates to a detecting device, and more particularly to a magnetic device for measuring scour depth.

### BACKGROUND OF THE INVENTION

The sediment near a bridge pier or a river bank is often secured away by the water during a flood season or a powerful typhoon, and this may be a danger to the buildings located nearby. Therefore, measuring the depth that the sediment is scoured away is an important means to avoid disaster.

Among conventional approaches, one approach is to deploy scouring bricks around the bridge pier before the flood season and then analyze the scattering of the scouring bricks after the flood season so as to determine the scour depth, and then evaluate the security level for the bridge pier. However, it is difficult for this approach to carry out real-time monitoring and provide warnings to the immediate danger areas. Although some approaches can realize real-time monitoring (e.g., detecting devices implemented by utilizing sonar, electromagnetic waves, temperature, gravity, or cameras), these approaches have lots of disadvantages including high expense and difficulty in setting the devices, and it is unlikely to deploy a great amount of these devices.

### SUMMARY OF THE INVENTION

An objective of the present invention is to provide a magnetic device for measuring scour depth. The magnetic device can measure the depth that the sediment is scoured away by water flow in a low-cost and efficient manner.

To achieve the above objective, the present invention provides a magnetic device for measuring scour depth, said magnetic device being buried in a sediment that settles on a stream bed, and being used to measure the depth value indicating the depth that the sediment is scoured away by water flow, said magnetic device comprising: a plurality of scour detecting units buried in the sediment and disposed at intervals along the direction perpendicular to the surface of the water, in which each scour detecting unit comprises: one or more magnetic sources, and one or more magnetic detecting elements, configured to be apart from the magnetic source for a predetermined distance, the magnetic detecting element being utilized to detect the magnetic field generated by the magnetic source, wherein the magnetic detecting element detects a change of magnetic strength when the sediment at the position of the magnetic source and the magnetic detecting element is scoured away and the water flow changes the relative distance between the magnetic source and the magnetic detecting element, and wherein the scour depth and the location where the scour occurs are determined according to electronic signals corresponding to the magnetic strength detected by the respective magnetic detecting elements of the scour detecting units.

In another aspect, the present invention provides a magnetic device for measuring scour depth, said magnetic device being buried in a sediment that settles on a stream bed, and being used to measure the depth value indicating the depth that the sediment is scoured away by water flow, said magnetic device comprising: a fixed post inserted into the sediment vertically; a plurality of scour detecting units disposed on the fixed post at intervals, in which the intervals between the scour detecting units are the same, and each scour detecting unit comprises: an elastic element fastened to the fixed post; one or more magnetic sources connected to the fixed post through the elastic element; and one or more magnetic detecting elements fastened to the fixed post, the magnetic detecting element being configured to be apart from the magnetic source for a predetermined distance, and being utilized to detect the magnetic field generated by the magnetic source, wherein when the sediment at the position of the magnetic source and the magnetic detecting element is scoured away and the water flow impacts the elastic element such that the magnetic source vibrates, the magnetic detecting element outputs electronic signals corresponding to changes of magnetic strength, and the scour depth and the location where the scour occurs are determined according to the electronic signals.

In the present invention, the linearly arranged scour detecting units may be buried in the sediment before the flood season, and by detecting the magnetic strength variation, the position where scour occurs can be determined, thereby obtaining the scour depth. Compared to conventional skills, the magnetic scour depth measuring device implemented according to the present invention has many advantages including low cost, simplicity, and such a device is easily deployed. The present invention can carry out real-time monitoring and provide warnings for the bridges and the buildings near the river bank during the flood season, and also can realize back silting monitoring.

### BRIEF DESCRIPTION OF THE DRAWINGS

FIG. 1 is a schematic diagram showing a magnetic device arranged near a bridge pier for measuring scour depth in accordance with the present invention.

FIG. 2 is a schematic diagram showing signal waveforms outputted by the respective magnetic detecting elements shown in FIG. 1.

FIG. 3 is a schematic diagram showing a scour detecting unit in accordance with an embodiment of the present invention.

FIG. 4 is a schematic diagram showing a scour detecting unit in accordance with another embodiment of the present invention.

FIG. 5 is a schematic diagram showing magnetic flux densities varied with distance in accordance with the embodiments shown in FIG. 3 and FIG. 4.

FIG. 6 is a schematic diagram showing a scour detecting unit in accordance with still another embodiment of the present invention.

### DETAILED DESCRIPTION OF THE INVENTION

A magnetic device for measuring scour depth is provided in the present invention. The magnetic device can be deployed near a bridge pier or a river bank to detect the scour depth and monitor the scouring degree during the flood season. In the present invention, the position where scour occurs is determined according to electronic signals generated by the magnetic device. Therefore, the present invention can realize real-time monitoring and provide warnings during the flood season to maintain security of cars on bridges or residents near to the river bank.

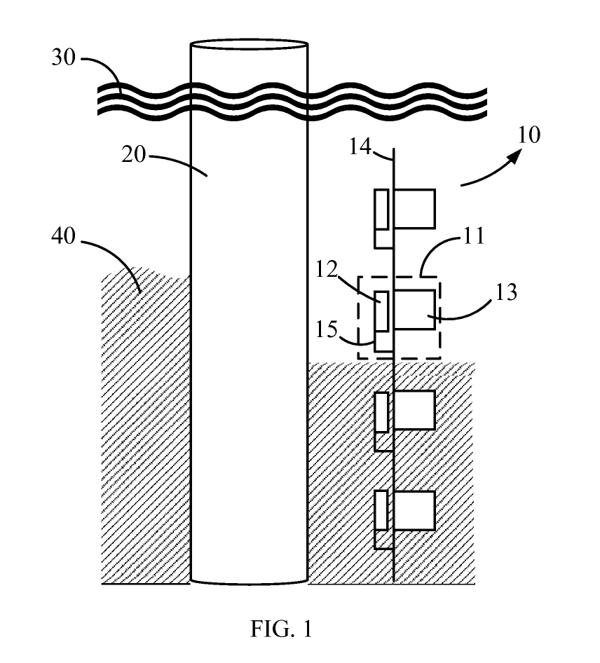

FIG. 1 is a schematic diagram showing a magnetic device 10 arranged near a bridge pier 20 for measuring scour depth in accordance with the present invention. The magnetic scour depth measuring device 10 of the present invention is deployed near the bridge pier 20 for monitoring the sediment 40, which is near the bridge pier 20 and under the surface of water 30, and the sediment scour resulted from water flow. When the magnetic device 10 is deployed, the magnetic device 10 is buried in the sediment 40 that settles at the stream bed or riverbed. As the sediment is scoured away by the water, the magnetic device 10 can detect or measure the depth value indicating the depth of the lost sediment. In FIG. 1, a part of the sediment has been scoured away after the magnetic device 10 is deployed, and thus some elements or components of the magnetic device 10 are exposed.

As shown in FIG. 1, the magnetic device 10 of the present invention comprises a plurality of scour detecting units 11. Each scour detecting unit 11 comprises one or more magnetic sources 12, and one or more magnetic detecting elements 13. The magnetic source 12 may be implemented by a permanent magnet or an electromagnet. The magnetic detecting element 13 may be implemented by a Hall effect sensor. When the magnetic device 10 is deployed, the scour detecting units 11 are buried in the sediment 40 along a direction perpendicular to the surface of the water 30. Specifically, the scour detecting units 11 are lined up along a vertical straight line and are arranged at intervals.

In each scour detecting unit 11, the magnetic source 12 and the magnetic detecting element 13 are configured to be apart from each other for a predetermined distance. The magnetic source 12 is used to generate a magnetic field. The magnetic detecting element 13 is able to detect the magnetic field generated by the magnetic source 12. When the distance between the magnetic source 12 and the magnetic detecting element 13 is changed, the magnetic strength detected by the magnetic detecting element 13 changes as well. It is assumed that four scour detecting units 11 shown in FIG. 1 are labeled as NO. 1, NO. 2, NO. 3, and NO. 4 from top to bottom. When the sediment corresponding to the scour detecting units 11 (e.g., NO. 1 and NO. 2 scour detecting units) is scoured away by the water flow, the water flow may change the distance between the magnetic source 12 and the magnetic detecting element 13, and further the magnetic detecting element 13 detects a change of magnetic strength and outputs signals or signal waveforms corresponding to the magnetic strength variation.

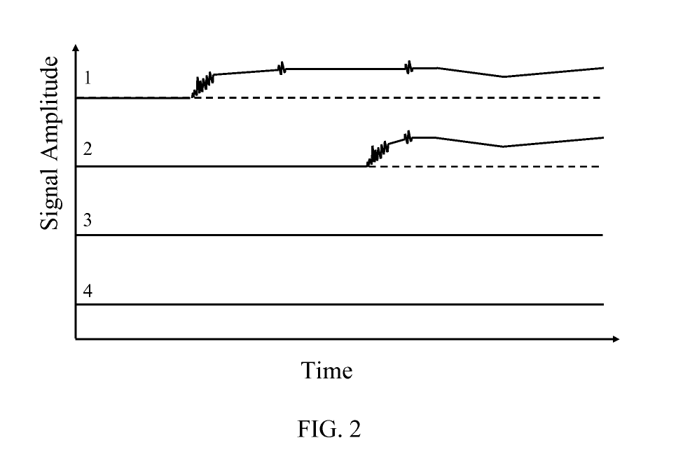

As shown in the signal waveforms in FIG. 2, the magnetic detecting elements 13 of NO. 1 and NO. 2 scour detecting units output signal waveforms corresponding to the magnetic strength variation since the sediment corresponding to these scour detecting units has been scoured away by the water. Meanwhile, the amplitudes of the signals outputted by NO. 3 and NO.4 scour detecting units remain unchanged or change a little since these scour detecting units are still buried in the sediment. In addition, since NO. 1 scour detecting unit is located above NO. 2 scour detecting unit, the sediment near NO. 1 scour detecting unit will be scoured away in advance, and accordingly the magnetic detecting element 13 of NO. 1 scour detecting unit will detect a change of magnetic strength prior to the magnetic detecting element 13 of NO. 2 scour detecting unit.

Therefore, the scour depth and the position where scour occurs can be determined according to the electronic signals outputted by the respective magnetic detecting elements 13. Whether back silting has occurred can be determined as well. For instance, the outputted electronic signals of the respective magnetic detecting elements 13 are detected. When an electronic signal outputted from some particular magnetic detecting element 13 has a specific waveform (e.g., strong fluctuation and varied amplitudes), it can be determined that scour occurs at the position of that magnetic detecting element 13. For example, as shown in FIG. 2, the magnetic detecting elements 13 of NO. 1 and NO. 2 scour detecting units output electronic signals having specific waveforms. Accordingly, it can determined that the sediment near NO. 1 and NO. 2 scour detecting units has been scoured away, and the scour depth corresponds to the position of NO. 2 scour detecting unit.

Specifically, as shown in FIG. 1, the magnetic device 10 of the present invention further comprises a fixed post 14, which is inserted into the sediment vertically. The scour detecting units 11 are disposed on the fixed post 14 along a length direction of the fixed post 14 and are arranged at intervals. The intervals between the scour detecting units 11 are the same. Each scour detecting unit 11 has an elastic element (e.g., a spring leaf) 15, which is fastened to the fixed post 14. The magnetic source 12 of each scour detecting unit 11 is connected to the fixed post 14 through the elastic element 15 while the magnetic detecting element 13 is fastened to the fixed post 14.

In such a manner, when the water impacts the scour detecting unit 11, the magnetic detecting element 13 remains stationary or moves slightly. Meanwhile, the magnetic source 12 vibrates or shifts its position since the water impacts the elastic element 15. Accordingly, the magnetic strength detected by the magnetic detecting element 13 varies and the corresponding outputted electronic signal has a specific waveform. Therefore, the position where scour occurs can be determined by detecting the specific signal waveform.

In another embodiment, the magnetic source 12 is fastened to the fixed post 14 while the magnetic detecting element 13 is connected to the fixed post 14 through the elastic element.

Basically, the present invention can be carried out as long as the magnetic source 12 and the magnetic detecting element 13 move relatively. In the above illustrated embodiment, the moving object is the magnetic source 12. However, the present invention is also applicable to the cases in which only the magnetic detecting element 13 moves, or both of the magnetic source 12 and the magnetic detecting element 13 move. Nevertheless, the arrangement of fixed magnetic detecting element 13 can reduce the difficulty of electric wiring. Also, the relative motion between the magnetic source 12 and the magnetic detecting element 13 is less likely to be affected by wiring cables. In addition, other types of motions can be implemented in the present invention as well, except for vibration.

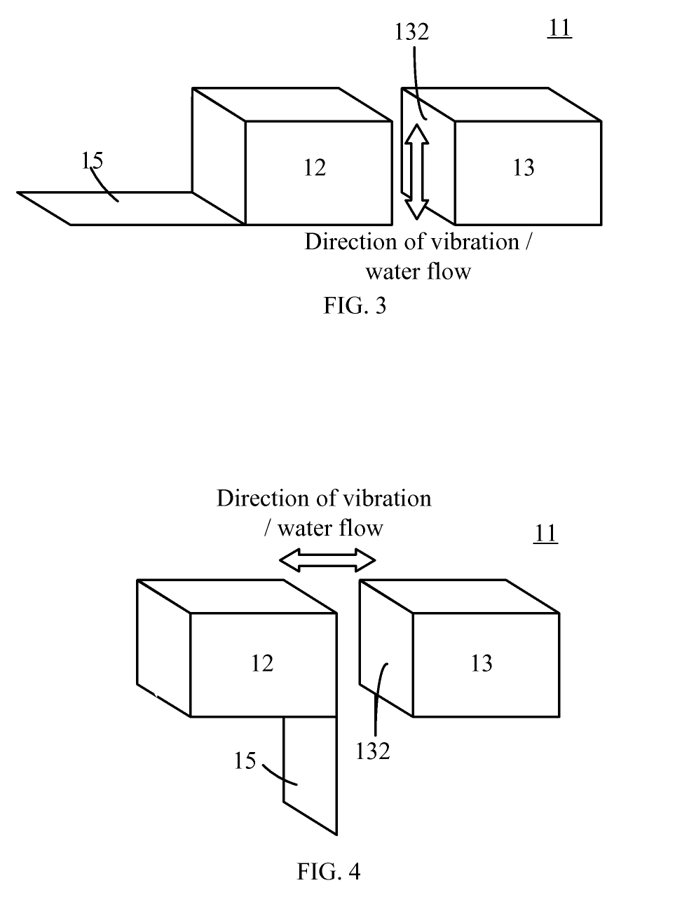

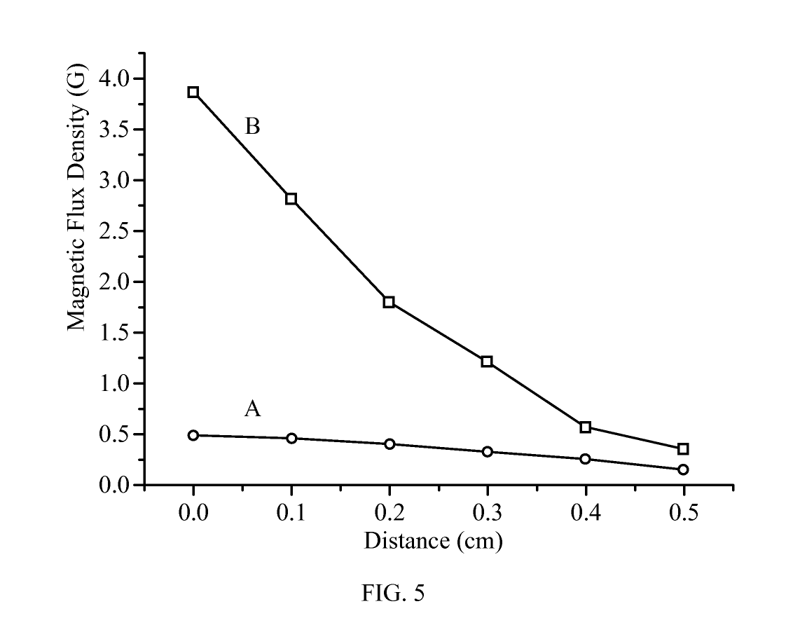

Referring to FIG. 3, in one embodiment, the magnetic source 12 vibrates and the direction of the vibration is substantially parallel to a detecting surface 132 of the magnetic detecting element 13, which is the surface nearest to the magnetic source 12. That is to say, the magnetic source 12 vibrates substantially along the direction parallel to the detecting surface 132 of the magnetic detecting element 13. Meanwhile, the magnetic flux densities measured at various distances by the magnetic detecting element 13 are similar to Curve A shown in FIG. 5.

Referring to FIG. 3, in one embodiment, the magnetic source 12 vibrates and the direction of the vibration is substantially parallel to the detecting surface 132 of the magnetic detecting element 13, which is the surface nearest to the magnetic source 12. That is to say, the magnetic source 12 vibrates substantially along the direction parallel to the detecting surface 132 of the magnetic detecting element 13. Meanwhile, the magnetic flux densities measured at various distances by the magnetic detecting element 13 are similar to Curve A shown in FIG. 5.

Referring to FIG. 4, in another embodiment, the magnetic source 12 vibrates and the direction of the vibration is substantially perpendicular to the detecting surface 132 of the magnetic detecting element 13. That is to say, the magnetic source 12 vibrates substantially along the direction perpendicular to the detecting surface 132 of the magnetic detecting element 13. Meanwhile, the magnetic flux densities measured at various distances by the magnetic detecting element 13 are similar to Curve B shown in FIG. 5.

As can be seen from the embodiments shown in FIG. 3 and FIG. 4, the arrangement shown in FIG. 4 is more sensitive to the displacement of the magnetic source 12. The scour detecting element 11 of FIG. 4 is suitable for being deployed at an area where the speed of the current is low. Relatively speaking, the arrangement shown in FIG. 3 is less sensitive to the displacement of the magnetic source 12. The scour detecting element 11 of FIG. 3 is suitable for being deployed in an area where the speed of the current is high. Accordingly, the two illustrated embodiments can be appropriately selected for different speeds of current.

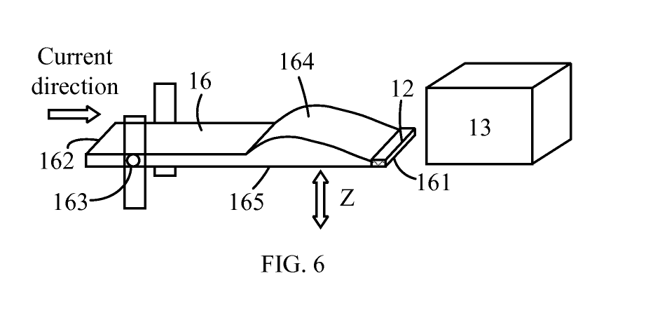

Referring to FIG. 6, in still another embodiment, the magnetic source 12 is arranged on an edge 161 of a board 16, and an opposite edge 162 of the board 16 is pivotally attached to a pivotal mechanism 163. The board 16 has a convex surface 164 on the top surface thereof. The bottom surface of the board 16 is a flat surface 165. The board 16 is arranged along the current direction. The movement of the board 16 makes the magnetic source 12 be located at a high position when the current is at high speed. In contrast, the movement of the board 16 makes the magnetic source 12 be located at a low position when the current is at low speed. Since the velocity of the current changes over time, the magnetic source 12 may move to and fro in a Z direction shown in FIG. 6. Accordingly, the magnetic detecting element 13 detects a higher magnetic strength when the magnetic source 12 is at the high position, and the magnetic detecting element 13 detects a lower magnetic strength when the magnetic source 12 is at the low position. When the sediment is scoured away and the water flows through the board 16, the magnetic detecting element 13 shown in the embodiment of FIG. 6 can detect a change of magnetic strength, and is thereby able to determine the scour depth.

In the present invention, the linearly arranged scour detecting units may be buried in the sediment before the flood season, and by detecting the magnetic strength variation the position where scour occurs can be determined, and thereby the scour depth is obtained. Compared to conventional skills, the magnetic scour depth measuring device implemented according to the present invention has many advantages including low cost, simplicity, and such a device is easily deployed. The present invention can carry out real-time monitoring and provide warnings for bridges and buildings near the river bank during the flood season, and also can realize back silting monitoring.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A magnetic device for measuring scour depth, said magnetic device being buried in a sediment that settles on a stream bed, and being used to measure a depth value indicating a depth that the sediment is scoured away by water flow, said magnetic device comprising:
a plurality of scour detecting units, buried in the sediment and disposed at intervals along a direction perpendicular to a surface of water, in which each scour detecting unit comprises:
one or more magnetic sources; and
one or more magnetic detecting elements, configured to be apart from the magnetic source for a predetermined distance, the magnetic detecting element being utilized to detect a magnetic field generated by the magnetic source,
wherein the magnetic detecting element detects a change of magnetic strength when the sediment at a position of the magnetic source and the magnetic detecting element is scoured away and the water flow changes a relative distance between the magnetic source and the magnetic detecting element, and wherein the scour depth and a location where scour occurs are determined according to electronic signals corresponding to the magnetic strength detected by the respective magnetic detecting elements of the scour detecting units.

2. The magnetic device according to claim 1, further comprising:
a fixed post inserted into the sediment vertically, wherein the scour detecting units are disposed on the fixed post at intervals.

3. The magnetic device according to claim 2, wherein intervals between the scour detecting units are the same.

4. The magnetic device according to claim 2, wherein each magnetic detecting element is fastened to the fixed post and each magnetic source is connected to the fixed post through an elastic element.

5. The magnetic device according to claim 4, wherein when the sediment at the position of the magnetic source is scoured away, the water flow impacts the elastic element such that the magnetic source vibrates, and wherein the direction of the vibration is substantially parallel to a detecting surface of the magnetic detecting element.

6. The magnetic device according to claim 4, wherein when the sediment at the position of the magnetic source is scoured away, the water flow impacts the elastic element such that the magnetic source vibrates, and wherein the direction of the vibration is substantially perpendicular to a detecting surface of the magnetic detecting element.

7. The magnetic device according to claim 2, wherein each magnetic source is fastened to the fixed post and each magnetic detecting element is connected to the fixed post through an elastic element.

8. The magnetic device according to claim 1, wherein the magnetic source is arranged on an edge of a board, the board has a convex surface on a top surface thereof, and a bottom surface of the board is a flat surface, and wherein when the water flow is at a high velocity, the movement of the board makes the magnetic source become located at a high position, and when the water flow is at a low velocity, the movement of the board makes the magnetic source become located at a low position.

9. The magnetic device according to claim 1, wherein the magnetic detecting element comprises a Hall effect sensor.

10. A magnetic device for measuring scour depth, said magnetic device being buried in a sediment that settles on a stream bed, and being used to measure a depth value indicating a depth that the sediment is scoured away by water flow, said magnetic device comprising:
a fixed post inserted into the sediment vertically;
a plurality of scour detecting units disposed on the fixed post at intervals, in which intervals between the scour detecting units are the same, and each scour detecting unit comprises:
an elastic element fastened to the fixed post;
one or more magnetic sources connected to the fixed post through the elastic element; and
one or more magnetic detecting elements fastened to the fixed post, the magnetic detecting element being configured to be apart from the magnetic source for a predetermined distance, and being utilized to detect a magnetic field generated by the magnetic source,
wherein when the sediment at a position of the magnetic source and the magnetic detecting element is scoured away and the water flow impacts the elastic element such that the magnetic source vibrates, the magnetic detecting element outputs electronic signals corresponding to changes of magnetic strength, and the scour depth and a location where scour occurs are determined according to the electronic signals.

11. The magnetic device according to claim 10, wherein a vibration direction of the magnetic source is substantially parallel to a detecting surface of the magnetic detecting element.

12. The magnetic device according to claim 10, wherein a vibration direction of the magnetic source is substantially perpendicular to a detecting surface of the magnetic detecting element.
